(19) United States
(12) Patent Application Publication
(10) Pub. No.: US 2017/0347071 A1
(43) Pub. Date: Nov. 30, 2017

(54) Projection Apparatus and Method

(71) Applicant: Huawei Technologies Co., Ltd., Shenzhen (CN)

(72) Inventor: Tao Lin, Shenzhen (CN)

(21) Appl. No.: 15/635,565

(22) Filed: Jun. 28, 2017

Related U.S. Application Data
(63) Continuation of application No. PCT/CN2016/102008, filed on Oct. 13, 2016.

(30) Foreign Application Priority Data
May 27, 2016 (CN) 201610370520.0

(51) Int. Cl. H04N 9/31

(52) U.S. Cl. CPC H04N 9/3135; H04N 9/3194

(57) ABSTRACT

A projection apparatus includes a projection cavity, a light source, a scanning motor, and a processor. The light source and the scanning motor are located inside the projection cavity, and the processor is connected to both the light source and the scanning motor. A reflection layer is disposed on a scanning mirror of the scanning motor, where the reflection layer is configured to reflect light emitted by the light source.

### CROSS-REFERENCE TO RELATED APPLICATIONS

This application is a continuation application of International Patent Application No. PCT/CN2016/102008, filed on Oct. 13, 2016, which claims priority to Chinese Patent Application No. 201610370520.0, filed on May 27, 2016. The disclosures of the aforementioned applications are hereby incorporated herein by reference in their entireties.

### TECHNICAL FIELD

The disclosure relates to the field of electronic technologies, and in particular, to a projection apparatus and method.

### BACKGROUND

Nowadays, near-eye light field display is used in augmented reality (AR), virtual reality (VR) and other technologies, and can bring more real three-dimensional (3D) display effects. Therefore, the near-eye light field display has become a development trend of future 3D display technologies. In a light field display technology, a wide-view-angle microprojection device is a basic component for generating a light field, and many manufacturers are investing much in research of the wide-view-angle microprojection device. In a digital light processing (DLP) system, a size of a digital micromirror device (DMD) determines a size of projection field of view (FOV), that is, a larger DMD indicates larger projection FOV, and a smaller DMD indicates smaller projection FOV. However, it is difficult to manufacture larger DMDs because of a current semiconductor manufacturing process. Projection FOV of a current DLP projection system is limited by a size of a DMD, and a corresponding projection angle of view of the projection FOY is too small to meet viewing requirements of users. In addition, large-size DMDs are expensive, and therefore, implementation costs for enlarging the projection FOV by increasing the size of the DMD are high.

In a prior art, a micro-electro-mechanical system (MEMS) is used to perform projection, and drives a mirror to perform scanning by using a piezoceramic motor or an electromagnetic technology, where the mirror rotates around a center. However, when the scanning is performed by the mirror rotating around the center, because projection FOV is limited by a maximum rotation angle of the mirror but currently the maximum rotation angle of the mirror is small, a projection angle of view corresponding to the projection FOV is still too small to meet viewing requirements of users.

In another prior art, a fiber scanning and projection technology is used to perform projection. A micro motor drives an optical fiber to a resonance state, and fiber scanning is used to achieve a large projection angle of view to obtain a projection FOV that can meet viewing requirements of users. However, the prior art uses the micro motor to drive the optical fiber to the resonance state, which has high requirements on assembling. Factors including an extension length and material of the fiber and a position of the motor may all affect a resonance frequency of the entire system, and the operation is difficult and implementation costs are high.

### SUMMARY

The disclosure provides a projection apparatus and a projection method, so as to enlarge a reflection range of light and expand a projection angle of view.

A first aspect provides a projection apparatus, where the apparatus may include a projection cavity, a light source, a scanning motor, and a processor, where the light source and the scanning motor are located inside the projection cavity, and the processor is connected to both the light source and the scanning motor; and a reflection layer is disposed on a scanning mirror of the scanning motor, where the reflection layer is configured to reflect light emitted by the light source.

In the projection apparatus provided by the disclosure, the scanning motor may he disposed in the projection cavity, and the reflection layer may be disposed on the scanning mirror of the scanning motor. The processor drives the scanning motor to perform scanning, and the light emitted by the light source is reflected outside the projection cavity by the reflection layer on a scanning mirror of the scanning motor. The light emitted by the light source is reflected by the reflection layer, which can enlarge a reflection range of the light, and further can expand a projection angle of view and improve user experience of the projection apparatus.

With reference to the first aspect, in a first possible implementation, the reflection layer includes at least one of an electroplated coating, a vapor deposition coating, or an adhesive reflector.

The projection apparatus provided by the disclosure can electroplate a reflective coating on the scanning mirror of the scanning motor by means of electroplating, or deposit a reflective coating on the scanning mirror of the scanning motor by means of vapor deposition, or add an adhesive reflector to the scanning mirror of the scanning motor, which provides diversified forms of the reflection layer and applicability of the projection apparatus.

With reference to the first aspect, in a second possible implementation, a shape of the scanning mirror covered by the reflection layer is an arc surface.

The disclosure adds a reflection layer on the scanning mirror in the arc surface shape, which enables a scanning range of the light reflected outside the projection cavity to be larger than a scanning range of the scanning motor.

With reference to any one of the first aspect to the second possible implementation of the first aspect, in a third possible implementation, the projection cavity is formed by a bottom, a top and an inner wall; and a diffusion layer is disposed on the top of the projection cavity, where the diffusion layer is configured to diffuse the light reflected by the reflection layer outside the projection cavity.

In the disclosure, the diffusion layer may be disposed on the top of the projection cavity, and the diffusion layer diffuses the light reflected by the reflection layer outside the projection cavity, which further expands a projection angle of view and improve user experience.

With reference to the third possible implementation of the first aspect, in a fourth possible implementation, the diffusion layer includes a lens layer or a grating layer.

The diffusion layer provided by the disclosure may include the lens layer or the grating layer and the like, which provides diversified selections of the diffusion layer and improves applicability of the projection apparatus.

With reference to any one of the first aspect to the second possible implementation of the first aspect, in a fifth possible implementation, the projection cavity is formed by a bottom, a top and an inner wall; and the light source is located on the inner wall of the projection cavity, and the scanning motor is located on a connecting edge of the inner wall of the projection cavity and the bottom of the projection cavity.

In the projection apparatus provided by the disclosure, the light source may be located on the inner wall of the projection cavity, and the scanning motor may be disposed on the connecting edge of the inner wall and the bottom of the projection cavity, which can enlarge an irradiation range of the light emitted by the light source on the scanning motor, and further enlarge a range in which incident light irradiated on the reflection layer is reflected by the reflection layer.

With reference to the fifth possible implementation of the first aspect, in a sixth possible implementation, the projection apparatus further includes a photosensitive device and a feedback unit; and the photosensitive device is located on the inner wall of the projection cavity or the bottom of the projection cavity, one end of the feedback unit is connected to the photosensitive device, and the other end of the feedback unit is connected to the processor.

In the projection apparatus provided by the disclosure, the photosensitive device may be located on the inner wall of the projection cavity or the bottom of the projection cavity, thereby better collecting a shadow of the scanning motor that is projected on the photosensitive device under irradiation of the light source, and feeding back to the processor by the feedback unit. In this way, the processor adjusts a working mode of the projection apparatus, which improves controllability of the projection apparatus, and further, improves applicability of the projection apparatus.

With reference to the first aspect, in a seventh possible implementation, the scanning motor performs the rotary scanning in a specified scanning model set by the processor, and a diameter of a cover area of the reflection layer is less than or equals the product of a linear velocity of rotation of the scanning motor and a pulse width of the light source.

The projection apparatus provided by the disclosure can enlarge a reflection range of the reflection layer through the rotary scanning of the scanning motor, and the diameter of the cover area of the reflection layer is determined by the linear velocity of rotation of the scanning motor and the pulse width of the light source, which can ensure the clarity of an image projected by the projection apparatus and improve user experience of the projection apparatus.

A second aspect provides a projection method, where the method may include performing, by a scanning motor, rotary scanning in a specified scanning mode; and when light emitted by a light source is irradiated on a scanning mirror of the scanning motor, reflecting, by the scanning motor, the light by means of a reflection layer on the scanning mirror.

With reference to the second aspect, in a first possible implementation, the specified scanning mode includes at least one of a Z-scanning mode, a spiral scanning mode, or a circular scanning mode.

With reference to the second aspect, in a second possible implementation, a shape of the scanning mirror covered by the reflection layer is an arc surface; and an arc defined by the arc surface and a scanning arc defined by the scanning motor during the rotary scanning are concentric arcs.

### BRIEF DESCRIPTION OF DRAWINGS

To describe the technical solutions in the embodiments of the disclosure more clearly, the following briefly describes the accompanying drawings required for describing the embodiments. The accompanying drawings in the following description show merely some embodiments of the disclosure, and a person of ordinary skill in the art may still derive other drawings from these accompanying drawings without creative efforts.

FIG. 1 is a schematic structural diagram of a projection apparatus according to an embodiment of the disclosure;

FIG. 2 is another schematic structural diagram of a projection apparatus according to an embodiment of the disclosure;

FIG. 3 is still another schematic structural diagram of a projection apparatus according to an embodiment of the disclosure; and

FIG. 4 is a schematic flowchart of a projection method according to an embodiment of the disclosure.

### REFERENCE NUMERALS FOR THE DRAWINGS

1: Projection cavity; 11. Bottom of the projection cavity; 12. Top of the projection cavity; 13: Inner wall of the projection cavity; 3: Scanning motor; 31: Reflection layer; 4: Processor; 41: Feedback unit; 2: Light source; 5: Convex reflective surface; 6: Curve corresponding to a projection angle of view 1; 61: Curve corresponding to a projection angle of view 2; 7: Diffusion layer; 8: Photosensitive device.

### DESCRIPTION OF EMBODIMENTS

The following clearly describes the technical solutions in the embodiments of the disclosure with reference to the accompanying drawings in the embodiments of the disclosure, The described embodiments are merely some but not all of the embodiments of the disclosure. All other embodiments obtained by a person of ordinary skill in the art based on the embodiments of the disclosure without creative efforts shall fall within the protection scope of the disclosure.

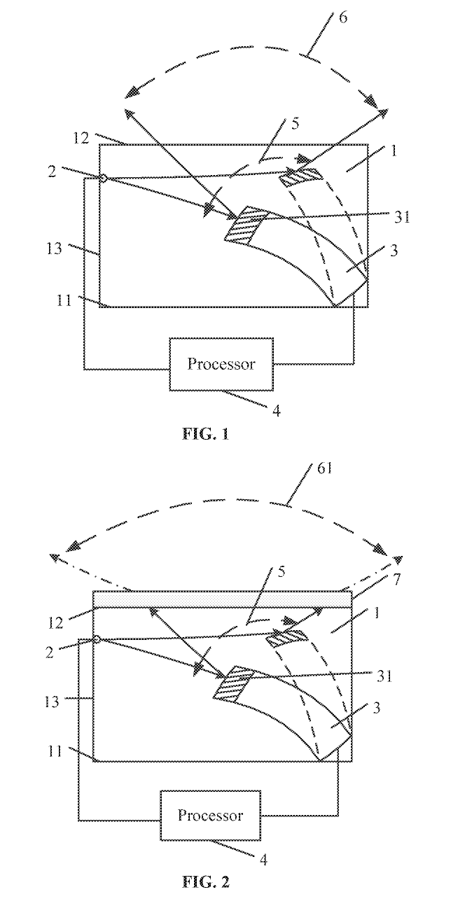

Referring to FIG. 1, FIG. 1 is a schematic structural diagram of a projection apparatus according to an embodiment of the disclosure. The projection apparatus provided in the embodiment of the disclosure includes a projection cavity 1, a light source 2, a scanning motor 3, and a processor 4.

In an implementation, the projection cavity 1 may be a polygonal prism projection cavity such as a cylindrical projection cavity, a cube projection cavity, a cuboid projection cavity, or a regular hexagonal prism projection cavity, which may be determined according to requirements of an actual application scenario or a manufacturing process of the apparatus and is not limited herein. The projection cavity shown in FIG. 1 is a front view of the projection cavity. The schematic diagram shown as FIG. 1 is used only for better describing the structural features of the projection apparatus, and more schematic drawings can be determined according to actual application scenarios. This is not limited herein.

In an implementation, the projection cavity may be formed by a bottom 11, a top 12 and an inner wall 13. If the projection cavity 1 is a cylindrical projection cavity, the inner wall 13 is a side surface of the projection cavity, and a stretch-out diagram of the side surface is a rectangle. If the projection cavity 1 is a cube projection cavity or a cuboid projection cavity, the inner wall 13 is four side surfaces of the projection cavity and each side surface is a square or a rectangle. If the projection cavity 1 is a regular hexagonal prism projection cavity, which is a polygonal prism projection cavity, the inner wall 13 is six side surfaces of the projection cavity and each side surface is a rectangle. The specific shape of the inner wall 13 of the projection cavity 1 may be determined according to an actual application scenario and is not limited herein.

The light source 2 and the scanning motor 3 are located inside the projection cavity 1. The light source 2 is disposed on the inner wall 13 of the projection cavity, and the scanning motor 3 is disposed on a connecting edge of the inner wall 13 of the projection cavity and the bottom 11 of the projection cavity. If the projection cavity 1 is a cylindrical projection cavity, the light source 2 is disposed at any position on the inner wall 13 of the projection cavity, and the scanning motor 3 may be disposed within an irradiation range of light emitted by the light source 2. If the projection cavity 1 is a polygonal prism projection cavity, the light source 2 may be disposed on any one of the side surfaces of the inner wall 13 of the projection cavity, and the scanning motor 3 may be disposed at a position on a surface opposite to the side surface on which the light source 2 is disposed, on a surface adjacent to a surface opposite to the side surface on which the light source 2 is disposed, or the like. The surface opposite to the side surface on which the light source 2 is disposed on or the surface opposite to the side surface on which the light source 2 is disposed and the adjacent surfaces thereof are any surface in the irradiation range of the light emitted by the light source 2. A fixing pin of the scanning motor 3 may be disposed on the inner wall 13 of the projection cavity 1, or on the bottom 11 of the projection cavity 1. The specific manner in which the scanning motor 3 is disposed may be determined according to an actual application scenario and is not limited herein.

A reflection layer 31 is disposed on a scanning mirror of the scanning motor 3. The reflection layer 31 is configured to reflect the light emitted by the light source 2 outside the projection cavity 1. A material of the reflection layer 31 may include an electroplated coating, a vapor deposition coating, or an adhesive reflector and the like. The electroplated coating may be an electroplated metal layer, and the vapor deposition coating may be a vapor deposition metal layer. The manner and material for fabricating the reflection layer 31 may be determined according to an actual application scenario and are not limited herein.

Further, a shape of a cover area of the reflection layer 31 covering the scanning mirror may include a circle, an equilateral polygon or an irregular pattern and the like, which may be determined according to the manufacturing process of the projection apparatus and is not limited herein. In embodiments of the disclosure, the maximum diameter of the cover area of the reflection layer 31 equals the product of a linear velocity of rotation during rotary scanning of the scanning motor 3 and a pulse width of the light source, which can ensure the clarity of a projected image and improve the display effect of the projected image. If the cover area of the reflection layer 31 is a circle, the diameter of the circle is the maximum diameter of the cover area. If the cover area of the reflection layer 31 is an equilateral polygon, the straight line distance between a center of the equilateral polygon and each vertex is the maximum radius. If the cover area of the reflection layer 31 is an irregular pattern, the irregular pattern may be divided into multiple small regular patterns, the maximum radius r of a small regular pattern among the small regular patterns is the maximum radius of the cover area, and radius of other small regular patterns are smaller than the maximum radius of the cover area. The pulse width determines the resolution of the projected image formed by the reflected light. If the maximum radius of the cover area of the reflection layer 31 is too large, the projected image becomes blurry. If the maximum radius of the cover area of the reflection layer 31 is too small, pixels of the projected image are distributed discontinuously, affecting the display effect of the image.

Further, a shape of the scanning mirror covered by the reflection layer 31 may be an arc surface, and an arc defined by the arc surface and a scanning arc defined by the scanning motor 3 during the rotary scanning are concentric arcs. When the scanning motor 3 performs the rotary scanning, a moving track of the reflection layer 31 on the scanning mirror of the scanning motor 3 can form a convex reflective surface. The convex reflective surface 5 as shown in FIG. 1 enables the scanning range of the light reflected outside the projection cavity to be larger than the scanning range of the scanning motor. The convex reflective surface 5 and the arc defined by the shape of the scanning mirror covered by the reflection layer 31 are concentric arcs. When the area of the reflection layer 31 is small enough, the shape of the scanning mirror covered by the reflection layer 31 is approximately a plane. When the area of the reflection layer is small enough, a central angle of the arc corresponding to the scanning mirror covered by the reflection layer is theta (θ), which satisfies a condition that Sine θ (sin θ) approximately equals θ.

The processor 4 may be disposed inside the projection cavity 1 or outside the projection cavity 1. This is not limited herein. The following description is provided by using an example in which the processor is disposed outside the projection cavity 1. The processor 4 is connected to both the light source 2 and the scanning motor 3.

In an implementation, the processor 4 can preset a scanning model for driving the scanning motor 3 to perform the rotary scanning, and store the scanning model in a memory (not shown in FIG. 1) of the projection apparatus. When the projection apparatus starts a working mode, the processor 4 can obtain, from the memory, a specified scanning mode output by the scanning model, and drive the scanning motor 3 to perform the rotary scanning according to the specified scanning mode. The processor 4 can determine, according to the preset specified scanning mode, scanning parameters such as a rotary direction, a scanning frequency, and a required scanning voltage during the rotary scanning of the scanning motor, and further can drive the scanning motor to perform the rotary scanning according to the scanning parameters. The specified scanning mode may include a Z-scanning mode, a spiral scanning mode, or a circular scanning mode. This is not limited herein.

Further, in an implementation, the processor 4 can determine, according to a relative position relationship between the scanning mirror and the light source 2 during the rotary scanning of the scanning motor 3, a direction of incident light on the reflection layer 31 of the scanning mirror when the light emitted by the light source irradiates on the scanning minor, and further determine a direction of reflected light when the incident light is reflected by the reflection layer 31. After the processor 4 determines the direction of the reflected light, light parameters of the light emitted by the light source can be determined according to data of an image to be projected stored in the memory, so that an image formed by the reflected light is the same as the image to be projected. The light parameters include light intensity, light colors and the like. After determining the light parameters, the processor 4 can drive the light source 2 according to the light parameters to generate light corresponding to the light parameters, and emit the light into the projection cavity, and the light is reflected outside the projection cavity 1 by means of the reflection layer 31 on the scanning mirror of the scanning motor.

For example, assuming that at a moment A, the scanning motor 3 reaches a position A1 (the solid line in FIG. 1) during the rotary scanning, the processor 4 can, according to the position A1 of the scanning motor 3 and the position of the light source 2, determine an angle of incidence Alpha1 (α1) of the incident light that is the light emitted by the light source 2 and that is irradiated on the reflection layer 31 at the moment. Further, the processor 4 can determine, according to the angle of incidence α1, an angle of reflection of the reflected light generated after the incident light is reflected by the reflection layer 31, and can further determine, according to the data of the image to be projected, light parameters such as light intensity and light colors required by projection in the angle of reflection. Assuming that at a moment B, the scanning motor 3 reaches a position B1 (the dashed line in FIG. 1) during the rotary scanning, the processor 4 can determine, according to the position B1 of the scanning motor 3 and the position of the light source 2, an angle of incidence α2 of the incident light that is the light emitted by the light source 2 and that is irradiated on the reflection layer 31 at the moment. Further, the processor 4 can determine, according to the angle of incidence α2, an angle of reflection of the reflected light generated after the incident light is reflected by the reflection layer 31, and can further determine, according to the data of the image to be projected, light parameters such as light intensity and light colors required by projection in the angle of reflection.

Through the rotary scanning of the scanning motor 3 and the reflection of light by the reflection layer 31, the projection apparatus enables the scanning range of the light reflected outside the projection cavity to be larger than the scanning range of the scanning motor, thereby achieving a larger projection angle of view (which is assumed to a be projection angle of view 1), for example, a central angle (not shown in FIG. 1) corresponding to the curve 6. The central angle corresponding to the curve 6 can be determined according to the angle of reflection of the light reflected by the reflection layer of the scanning motor 3 at the moment A and the angle of reflection of the light reflected by the reflection layer of the scanning motor 3 at the moment B. The specific angle may be determined according to an actual application scenario, and further details are not described herein.

Referring to FIG. 2, FIG. 2 is another schematic structural diagram of a projection apparatus according to an embodiment of the disclosure.

In some feasible implementations, the projection apparatus provided by this embodiment of the disclosure further includes a diffusion layer 7. The diffusion layer 7 may include a lens layer or a grating layer and the like, which may be determined according to the actual manufacturing process, and is not limited herein. Further, parameters such as the thickness and size of the diffusion layer 7 may also be determined according to factors such as the requirements of an actual application scenario and the manufacturing process, and are not limited herein.

In an implementation, the diffusion layer 7 is disposed on a top 12 of the projection cavity, and is configured to diffuse light reflected by the reflection layer 31 outside the projection cavity to achieve a larger projection angle of view (which is assumed to be a projection angle of view 2), for example, a central angle (not shown in FIG. 2) corresponding to the curve 61. The central angle corresponding to the curve 61 can be determined according to the angle of reflection of the light reflected by the reflection layer 31 of the scanning motor 3 at the moment A, the angle of reflection of the light reflected by the reflection layer 31 of the scanning motor 3 at the moment B, and light diffusion parameters (for example, a refractive index of a lens) of the material of the diffusion layer 7. The specific angle may be determined according to an actual application scenario, and further details are not described herein.

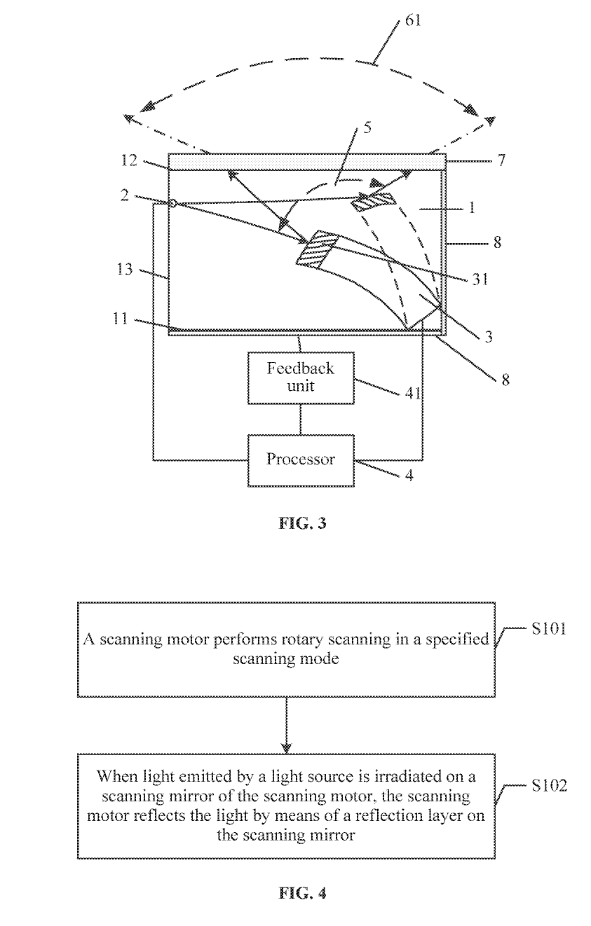

Referring to FIG. 3, FIG. 3 is still another schematic structural diagram of a projection apparatus according to an embodiment of the disclosure.

In some embodiments, the projection apparatus provided by this embodiment of the disclosure further includes a photosensitive device 8 and a feedback unit 41. The photosensitive device 8 is disposed on the inner wall 13 of the projection cavity 1 or on the bottom 11 of the projection cavity 1, or is disposed on the inner wall 13 and the bottom 11 of the projection cavity 1. If the projection cavity 1 is a cylindrical projection cavity, the photosensitive device 8 can be disposed on the inner wall with a specified area defined by a position of the fixing pin of the scanning motor 3. For example, assuming that the position of the fixing pin of the scanning motor 3 is M on the inner wall of the projection cavity 1, a parallel line L of the connecting edge of the inner wall 13 and the bottom 11 of the projection cavity 1 can be determined with M as a center. Assuming that the length of the parallel line L is a, and the height of the projection cavity 1 (that is, the width of the stretch-out diagram of the inner wall 13) is b, the area of a*b can be used as the specified area that is defined by the position of the fixing pin of the scanning motor 3. The photosensitive device 8 can be disposed on the inner wall with the specified area. If the projection cavity 1 is a polygonal prism projection cavity, the fixing pin of the scanning motor 3 is disposed on one of the multiple side surfaces of the inner wall 13. Assuming that the fixing pin of the scanning motor 3 is disposed on a side surface 1, the photosensitive device 8 can be disposed on the side surface 1. In an implementation, the position of the photosensitive device 8 on the inner wall or the bottom of the projection cavity 1 can be defined according to the position of the scanning motor 3. When light emitted by the light source 2 is irradiated on the scanning motor 3, the scanning mirror of the scanning motor 3 transmits the light of the light source 2, so that the scanning motor 3 forms a shadow on the bottom or the inner wall of the projection cavity 1. The photosensitive device 8 may be disposed at any position within the range of the shadow formed by the scanning motor 3 on the bottom or the inner wall of the projection cavity 1, for sensing the shadow of the scanning mirror of the scanning motor 3.

One end of the feedback unit 41 is connected to the photosensitive device 8, and the other end of the feedback unit 41 is connected to the processor 4. The feedback unit 41 is configured to calculate a position of the scanning mirror of the scanning motor 3 according to the shadow sensed by the photosensitive device 8, and feedback the position of the scanning mirror to the processor 4. The processor 4 compares a measured value of the position of the scanning mirror fed back by the feedback unit 41 with a measured value of the position of the scanning mirror estimated according to the preset scanning model, and determines a difference value between the measured values of the two positions, and can further correct the scanning model according to the difference value. The scanning model is corrected according to the feedback of the feedback unit 41, so the accuracy of estimating the position of the scanning mirror according to the scanning model is improved, and further, the quality of projected images and robustness of the system can be improved.

Referring to FIG. 4, FIG. 4 is a schematic flowchart of a projection method according to an embodiment of the disclosure. The projection method provided by the embodiment of the disclosure includes the following steps.

Step S101. A scanning motor performs rotary scanning in a specified scanning mode; and

Step S102. When light emitted by a light source is irradiated on a scanning mirror of the scanning motor, the scanning motor reflects the light by means of a reflection layer on the scanning mirror.

In some feasible implementations, the specified scanning mode includes at least one of a Z-scanning mode, a spiral scanning mode, or a circular scanning mode.

In some feasible implementations, a shape of the scanning mirror covered by the reflection layer is an arc surface; and an arc defined by the arc surface and a scanning arc defined by the scanning motor during the rotary scanning are concentric arcs.

In an implementation, for an implementation performed by the scanning motor in the projection method, refer to the implementation performed by the scanning motor in the foregoing embodiments, and details are not described herein again.

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include a magnetic disk, an optical disc, a read-only memory (ROM), or a random access memory (RAM).

What are disclosed above are merely exemplary embodiments of the disclosure, and certainly are not intended to limit the protection scope of the disclosure. Therefore, equivalent variations made in accordance with the claims of the disclosure shall fall within the scope of the disclosure.

What is claimed is:

1. A projection apparatus, comprising:
a projection cavity;
a light source;
a scanning motor;
a processor, wherein the light source and the scanning motor are located inside the projection cavity, and wherein the processor is coupled to both the light source and the scanning motor; and
a reflection layer disposed on a scanning mirror of the scanning motor, wherein the reflection layer is configured to reflect light emitted by the light source.

2. The projection apparatus according to claim 1, wherein the reflection layer comprises at least one of an electroplated coating, a vapor deposition coating, or an adhesive reflector.

3. The projection apparatus according to claim 1, wherein a shape of the scanning mirror covered by the reflection layer is an arc surface.

4. The projection apparatus according to claim 1, wherein the projection cavity is defined by a bottom, a top and an inner wall, wherein a diffusion layer is disposed on the top of the projection cavity, and wherein the diffusion layer is configured to diffuse the light reflected by the reflection layer outside the projection cavity.

5. The projection apparatus according to claim 4, wherein the diffusion layer comprises a lens layer.

6. The projection apparatus according to claim 1, wherein the projection cavity is formed by a bottom, a top and an inner wall, wherein the light source is located on the inner wall of the projection cavity, and wherein the scanning motor is located on a connecting edge of the inner wall of the projection cavity and the bottom of the projection cavity.

7. The projection apparatus according to claim 6, further comprising a photosensitive device and a feedback unit, wherein the photosensitive device is located on the inner wall of the projection cavity, wherein one end of the feedback unit is connected to the photosensitive device, and wherein the other end of the feedback unit is connected to the processor.

8. A projection method, comprising:
performing rotary scanning in a specified scanning mode; and
reflecting the light with a reflection layer on the scanning mirror when light emitted by a light source is irradiated on a scanning mirror of the scanning motor.

9. The projection method according to claim 8, wherein the specified scanning mode comprises at least one of a Z-scanning mode, a spiral scanning mode, or a circular scanning mode.

10. The projection method according to claim 8, wherein a shape of the scanning minor covered by the reflection layer is an arc surface, and wherein an arc defined by the arc surface and a scanning arc defined by the scanning motor during the rotary scanning are concentric arcs.

11. The projection apparatus according to claim 4, wherein the diffusion layer comprises a grating layer.

12. The projection apparatus according to claim 6, further comprising a photosensitive device and a feedback unit, wherein the photosensitive device is located on the bottom of the projection cavity, wherein one end of the feedback unit is connected to the photosensitive device, and wherein the other end of the feedback unit is connected to the processor.
